(19) United States
(12) Patent Application Publication
(10) Pub. No.: US 2021/0191798 A1
(43) Pub. Date: Jun. 24, 2021

(54) ROOT CAUSE IDENTIFICATION OF A PROBLEM IN A DISTRIBUTED COMPUTING SYSTEM USING LOG FILES

(71) Applicant: VMware, Inc., Palo Alto, CA (US)

(72) Inventors: Kate Zhang, Palo Alto, CA (US); Dexiang Wang, Palo Alto, CA (US); Michael Hu, Palo Alto, CA (US); Tengyuan Ye, Palo Alto, CA (US); Eduard Serra Miralles, Palo Alto, CA (US)

(73) Assignee: VMware, Inc., Palo Alto, CA (US)

(21) Appl. No.: 16/718,707

(22) Filed: Dec. 18, 2019

(51) Int. Cl. G06F 11/07; G06F 11/34

(52) U.S. Cl. CPC G06F 11/079; G06F 11/0775; G06F 11/3476

(57) ABSTRACT

Automated methods and systems described directed to determining a root cause of problem with a system executing in a distributed computing system. Methods and systems train a normal-state model that characterizes a normal state of the system based on normal log files generated by event sources of the system executed under normal or test conditions. Methods and systems use the normal-state model and a log file containing log messages recorded about the time when a problem with the system has been detected to identify log messages that describe a root cause of the problem.

### TECHNICAL FIELD

This disclosure is directed to automated methods and systems that identify a root cause of a problem with a tenant's system executing in a distributed computing system from log files associated with the tenant's system.

### BACKGROUND

Electronic computing has evolved from primitive, vacuum-tube-based computer systems, initially developed during the 1940s, to modern electronic computing systems in which large numbers of multi-processor computer systems, such as server computers, work stations, and other individual computing systems are networked together with large-capacity data-storage devices and other electronic devices to produce geographically distributed computing systems, such as data centers, with hundreds of thousands components that provide enormous computational bandwidths and data-storage capacities. These large, distributed computing systems are made possible by advances in computer networking, distributed operating systems and applications, data-storage appliances, computer hardware, and software technologies.

Because modern distributed computing systems have an enormous number of computational resources and execute thousands of applications, various management systems have been developed to receive performance information and aid IT administrators and application owners in detection of system problems. For example, a typical log management system records log messages generated by various operating systems and applications executing in a distributed computing system. Each log message records an event that indicates the state of an operating system, application, or service at a point in time or describes a success or failure of a computational operation. Events include I/O operations, alarms or warnings, errors, device start up and shut down, diagnostic information, and statistical information. IT administrators and application owners examine log messages to monitor system performance and search for root-causes of system problems. However, with the increase in scale and complexity of distributed computing systems, such as large-scale data centers, used to execute tens of thousands of applications and services, vast numbers of log files are generated each day with many log files exceeding a tera byte of data. Typical log management systems fail to keep pace with the increasing size and numbers of log files. As a result, it is becoming increasingly more challenging for IT administrators and application owners to examine log files for system problems, resulting in long delays in detection of root-causes of abnormal behavior.

### SUMMARY

Automated methods and systems described herein are directed to determining a root cause of a problem with a system executing in a distributed computing system. Methods and systems train a normal-state model that characterizes a normal state of the system based on normal log files generated by event sources of the system executed under normal or test conditions. The normal log files contain a high frequency of benign log messages and may contain a low frequency of problem-related log messages. The normal-state model is trained on the assumptions that 1) log messages identifying a root cause of a problem are infrequent or non-existent in the normal log files and 2) log messages describing the root cause of a problem are frequently recorded in one or more log files produced under real conditions at about the time when the problem occurred. Methods and systems use the normal-state model and a log file containing log messages recorded about the time when a problem with the system has been detected to identify log messages that describe a root cause of the problem.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows example virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer located above a physical data center.

FIG. 14 shows an example of logging log messages in log files.

FIG. 15 shows an example of a source code of an event source.

FIG. 16 shows an example of a log write instruction.

FIG. 17 shows an example of a log message generated by the log write instruction in FIG. 16.

FIG. 18 shows a small, eight-entry portion of a log file.

FIGS. 19A-19B show an example of the log management server receiving log messages from event sources.

FIG. 20 shows an example of event analysis performed on a log message.

FIG. 21 shows an example of three normal log files of a set of normal log files.

FIG. 22 shows a plot of an example normal-state model for a set of normal log files.

FIG. 23A shows an example of a problem log file.

FIG. 23B shows an example frequency spectrum of relevant tokens in a problem log file.

FIG. 24 shows a plot of example term frequency independent document frequency values calculated from normalized independent frequency values and term frequency values.

FIG. 25 shows an example of determining potential root cause in problem-related log messages of a problem log file.

FIG. 26 shows an example of determining potential root cause in problem-related log messages of the problem log file using information regarding a suspected time when time a system failure occurred.

FIG. 27 is a flow diagram illustrating an example implementation of a “method for determining a root cause of a problem with execution of a tenant's system in a distributed computing system.”

FIG. 28 is a flow diagram illustrating an example implementation of the “determine a normal-state model based on relevant tokens recorded in log messages of normal log files” step of FIG. 27.

FIG. 29 is a flow diagram illustrating “extract relevant tokens from log messages” step of FIG. 28.

FIG. 30 is a flow diagram illustrating an example implementation of the “determine relevant term frequencies of relevant tokens of problem-related log messages of a problem log file” step of FIG. 27.

FIG. 31 is a flow diagram illustrating an example implementation of the “determine a message score for each problem-related log message of the problem log file” step of FIG. 27.

### DETAILED DESCRIPTION

This disclosure presents automated methods and systems for using log files to identify a root causes of a problem with a system executing in a distributed computing system. In a first subsection, computer hardware, complex computational systems, and virtualization are described. Automated methods and systems that identify a root cause of a problem in a distributed computer system using log files are described below in a second subsection.

### Computer Hardware, Complex Computational Systems, and Virtualization

The term “abstraction” as used to describe virtualization below is not intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

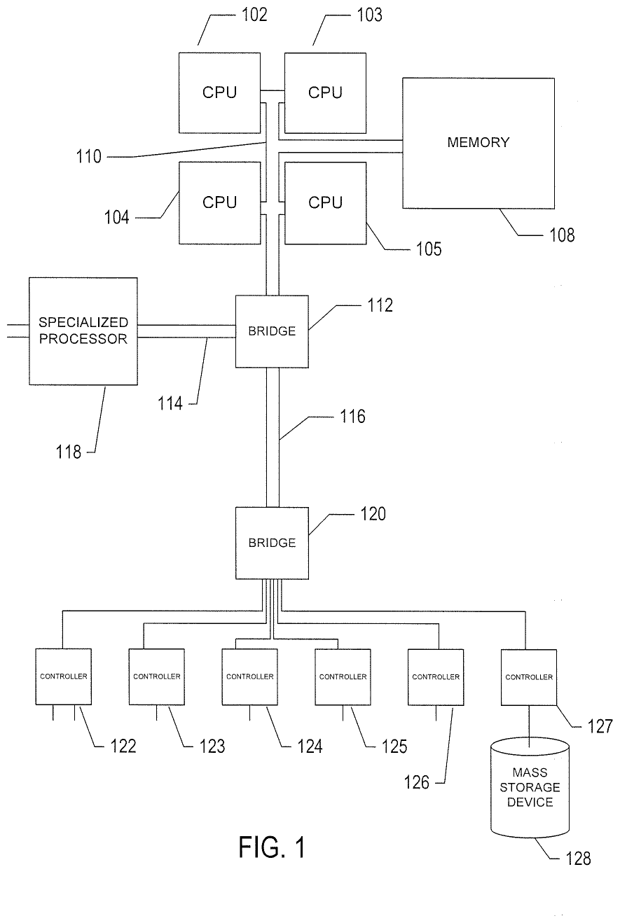

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

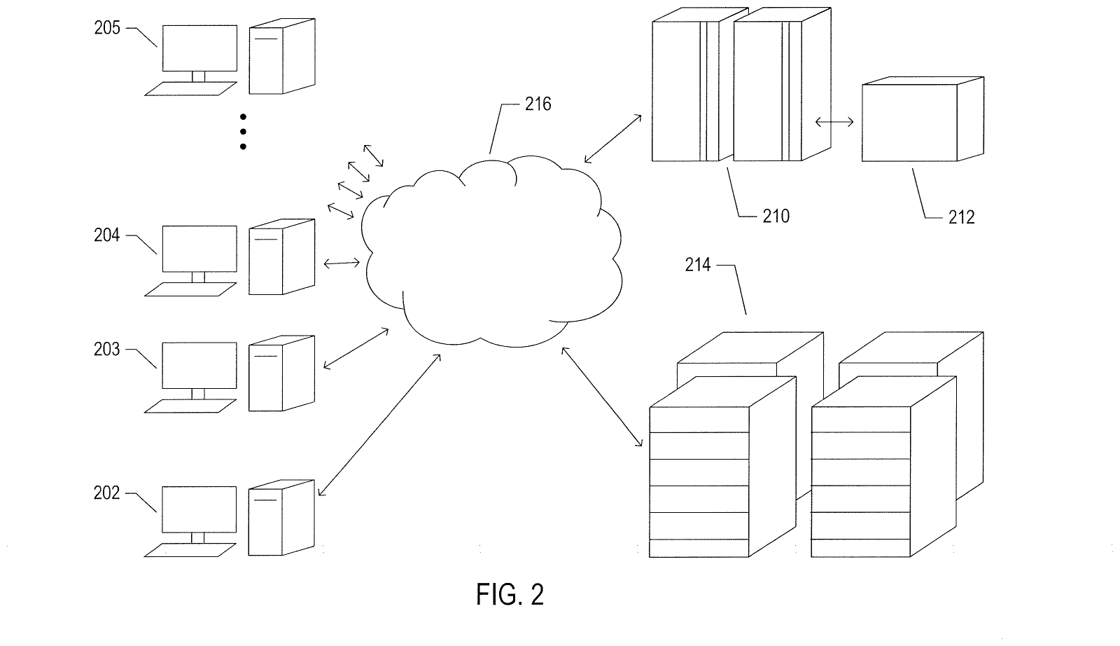

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

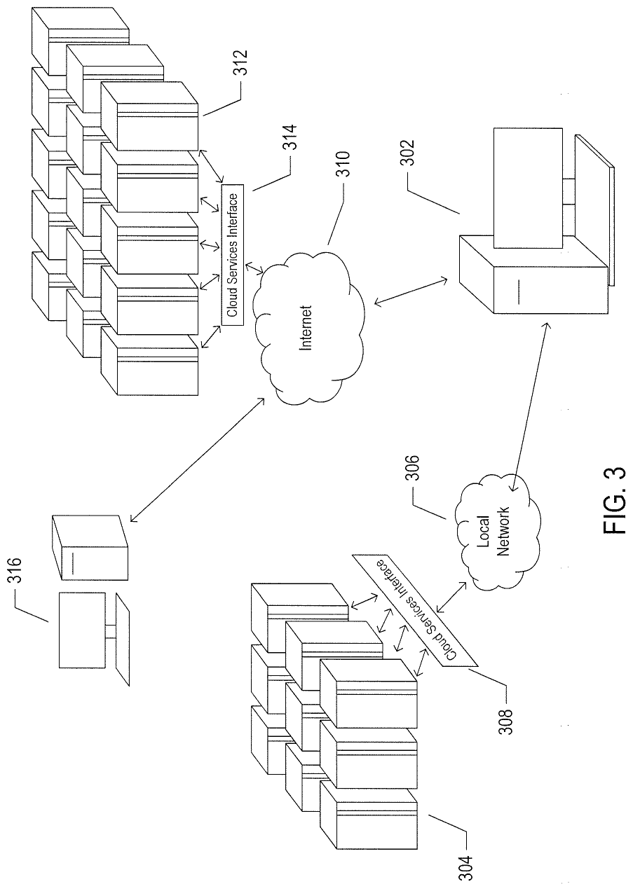

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

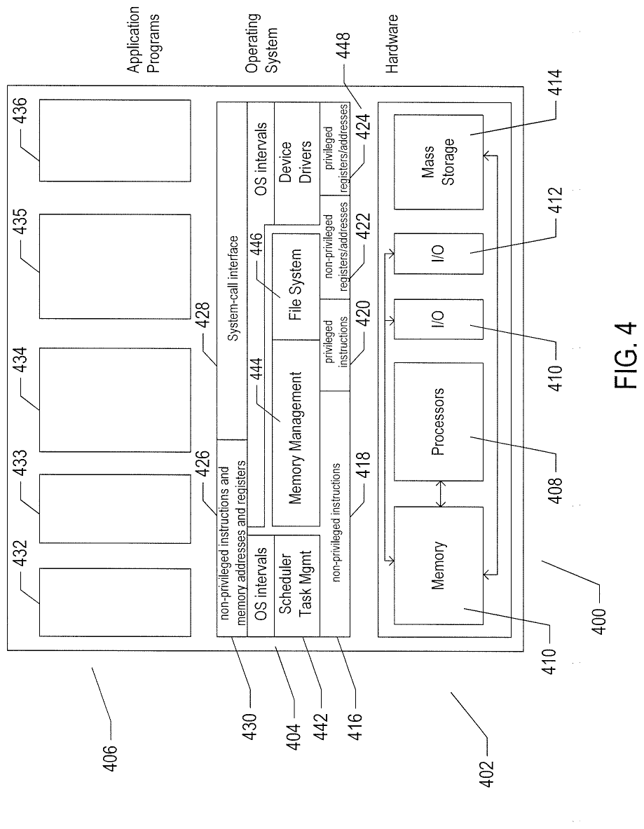

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

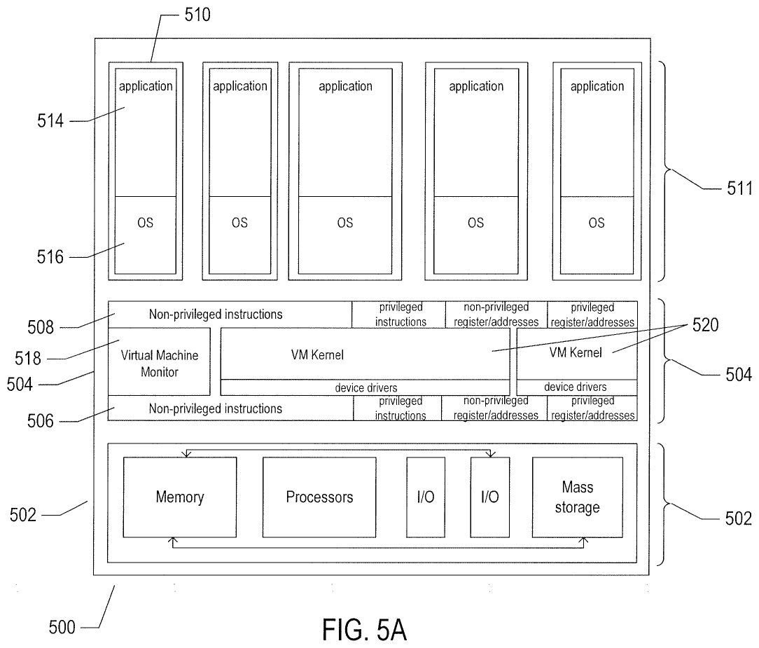

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

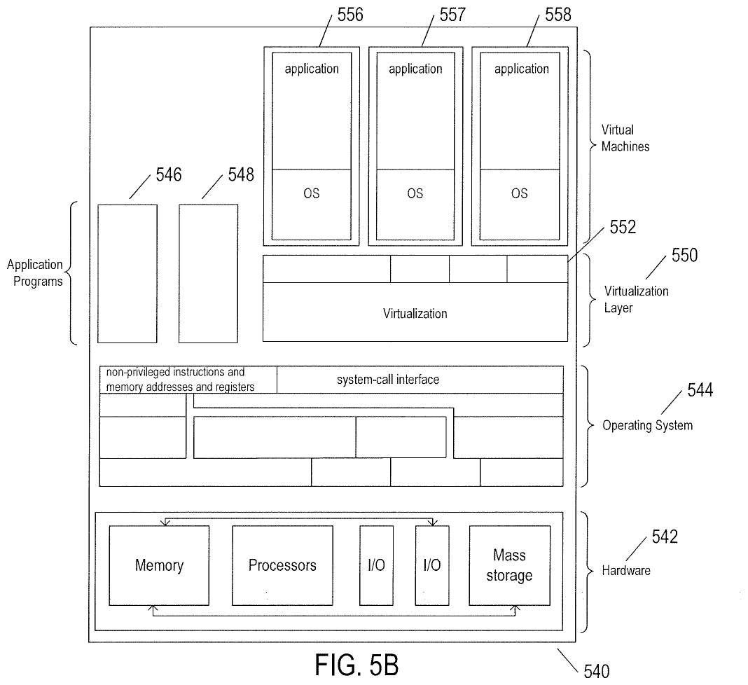

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing. XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

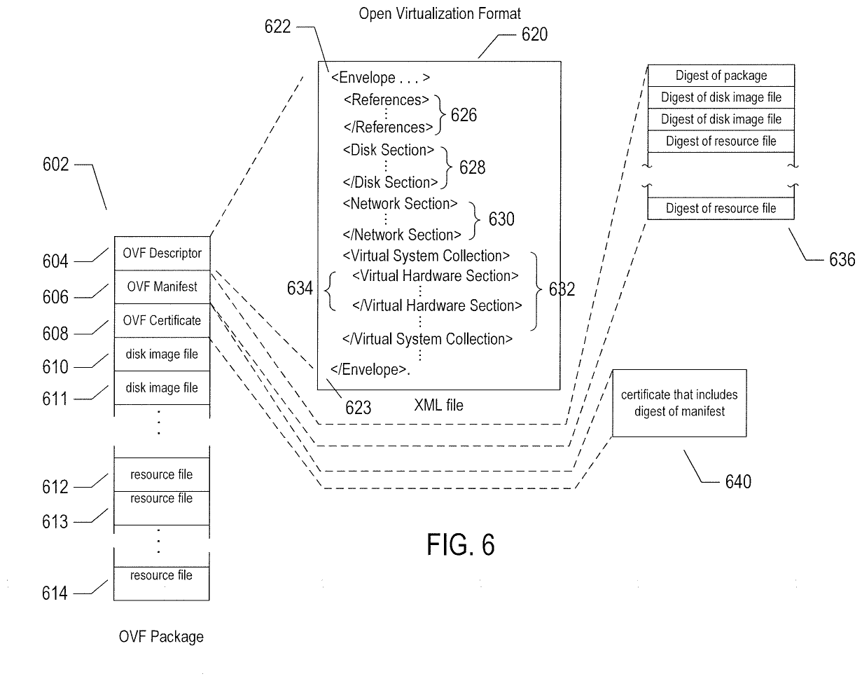

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

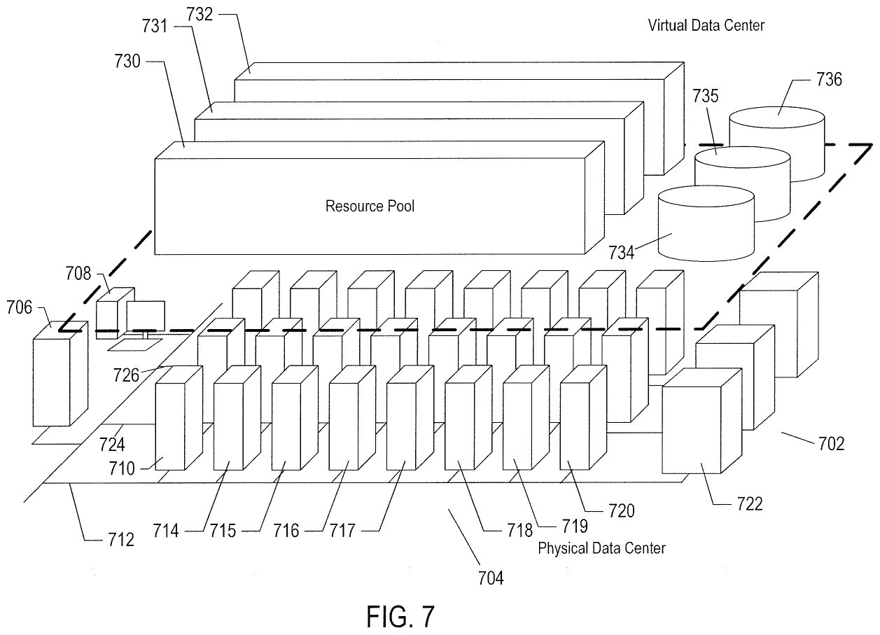

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

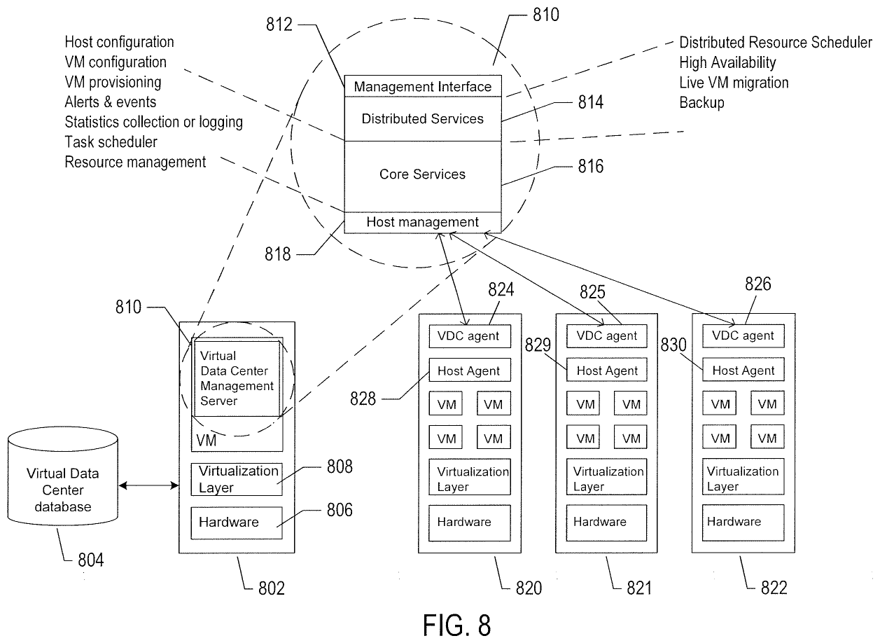

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

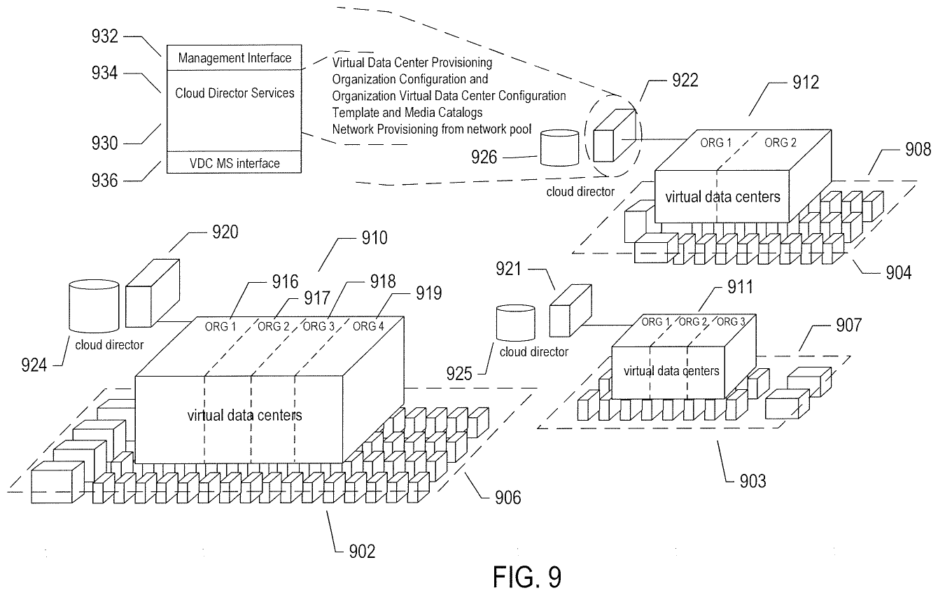

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloudTM VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

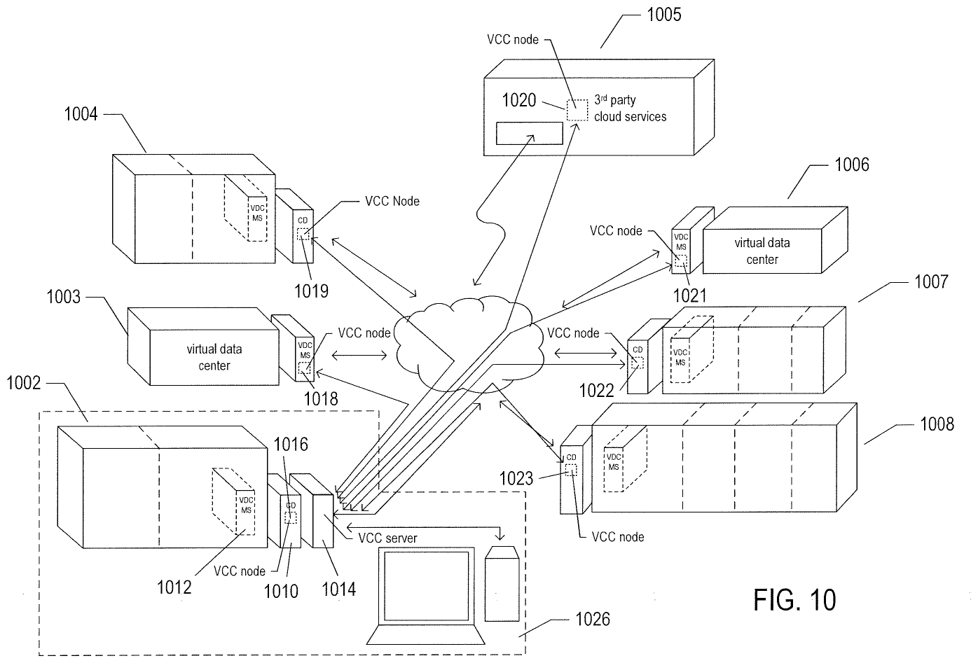

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

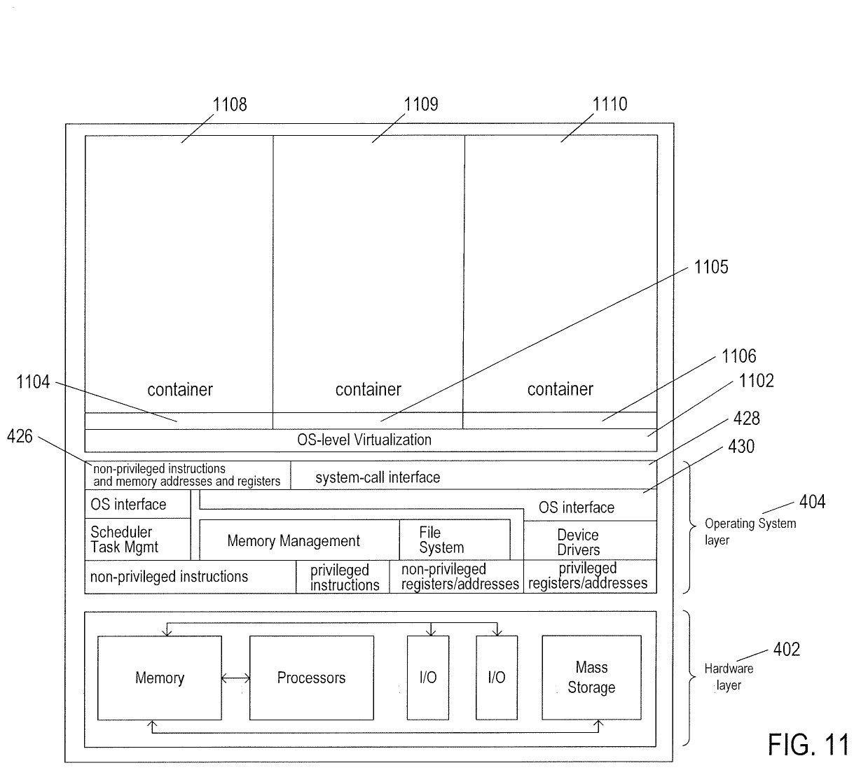

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Methods and Systems that Identify a Root Cause of a Problem in a Distributed Computing System Using Log Files

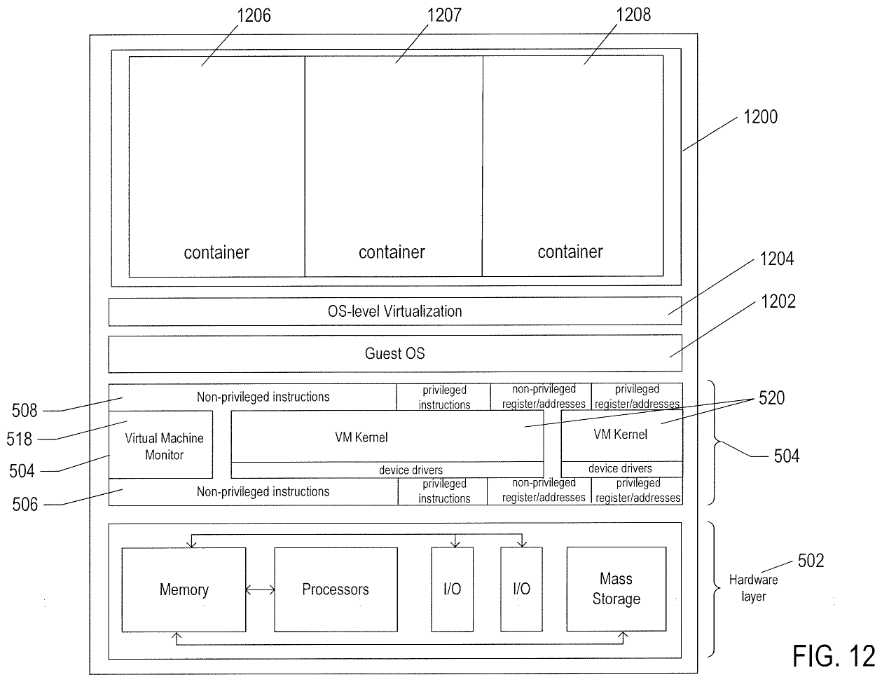

FIG. 13 shows an example of a virtualization layer 1302 located above a physical data center 1304. For the sake of illustration, the virtualization layer 1302 is separated from the physical data center 1304 by a virtual-interface plane 1306. The physical data center 1304 is an example of a distributed computing system. The physical data center 1304 comprises physical objects, including an administration computer system 1308, any of various computers, such as PC 1310, on which a virtual-data-center (“VDC”) management interface may be displayed to system administrators and other users, server computers, such as server computers 1312-1319, data-storage devices, and network devices. The server computers may be networked together to form networks within the data center 1304. The example physical data center 1304 includes three networks that each directly interconnects a bank of eight server computers and a mass-storage array. For example, network 1320 interconnects server computers 1312-1319 and a mass-storage array 1322. Different physical data centers may include many different types of computers, networks, data-storage systems and devices connected according to many different types of connection topologies. The virtualization layer 1302 includes virtual objects, such as VMs, applications, and containers, hosted by the server computers in the physical data center 1304. The virtualization layer 1302 may also include a virtual network (not illustrated) of virtual switches, routers, load balancers, and network interface cards formed from the physical switches, routers, and network interface cards of the physical data center 1304. Certain server computers host VMs and containers as described above. For example, server computer 1314 hosts two containers 1324, server computer 1326 hosts four VMs 1328, and server computer 1330 hosts a VM 1332. Other server computers may host applications as described above with reference to FIG. 4. For example, .server computer 1318 hosts four applications 1334. The virtual-interface plane 1306 abstracts the resources of the physical data center 1304 to one or more VDCs comprising the virtual objects and one or more virtual data stores, such as virtual data stores 1338 and 1340. For example, one VDC may comprise VMs 1328 and virtual data store 1338. Automated methods and systems described herein may be executed by a log management server 1342 implemented in one or more VMs on the administration computer system 1308. The log management server 1342 receives log messages generated by event sources and records the log messages in log files as described below.

### Log Messages

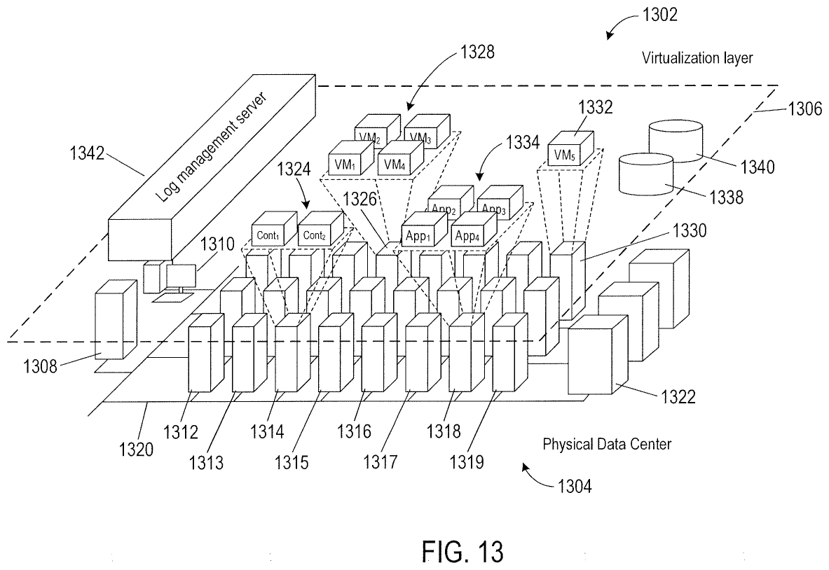

FIG. 14 shows an example of logging log messages in log files. In FIG. 14, computer systems 1402-1406 within a distributed computing system are linked together by an electronic communications medium 1408 and additionally linked through a communications bridge/router 1410 to an administration computer system 1412 that includes an administrative console 1414 and executes a log management server. Each of the computer systems 1402-1406 may run a log monitoring agent that forwards log messages to the log management server executing on the administration computer system 1412. As indicated by curved arrows, such as curved arrow 1416, multiple components within each of the discrete computer systems 1402-1406 as well as the communications bridge/router 1410 generate log messages that are forwarded to the log management server. Log messages may be generated by any event source. Event sources may be, but are not limited to, application programs, operating systems, VMs, guest operating systems, containers, network devices, machine codes, event channels, and other computer programs or processes running on the computer systems 1402-1406, the bridge/router 1410 and any other components of a distributed computing system. Log messages may be received by log monitoring agents at various hierarchical levels within a discrete computer system and then forwarded to the log management server executing in the administration computer system 1412. The log management server records the log messages in a data-storage device or appliance 1418 as log files 1420-1424. Rectangles, such as rectangle 1426, represent individual log messages. For example, log file 1420 may contain a list of log messages generated within the computer system 1402. Each log monitoring agent has a configuration that includes a log path and a log parser. The log path specifies a unique file system path in terms of a directory tree hierarchy that identifies the storage location of a log file on the administration computer system 1412 or the data-storage device 1418. The log monitoring agent receives specific file and event channel log paths to monitor log files and the log parser includes log parsing rules to extract and format lines of the log message into log message fields described below. Each log monitoring agent sends a constructed structured log message to the log management server. The administration computer system 1412 and computer systems 1402-1406 may function without log monitoring agents and a log management server, but with less precision and certainty.

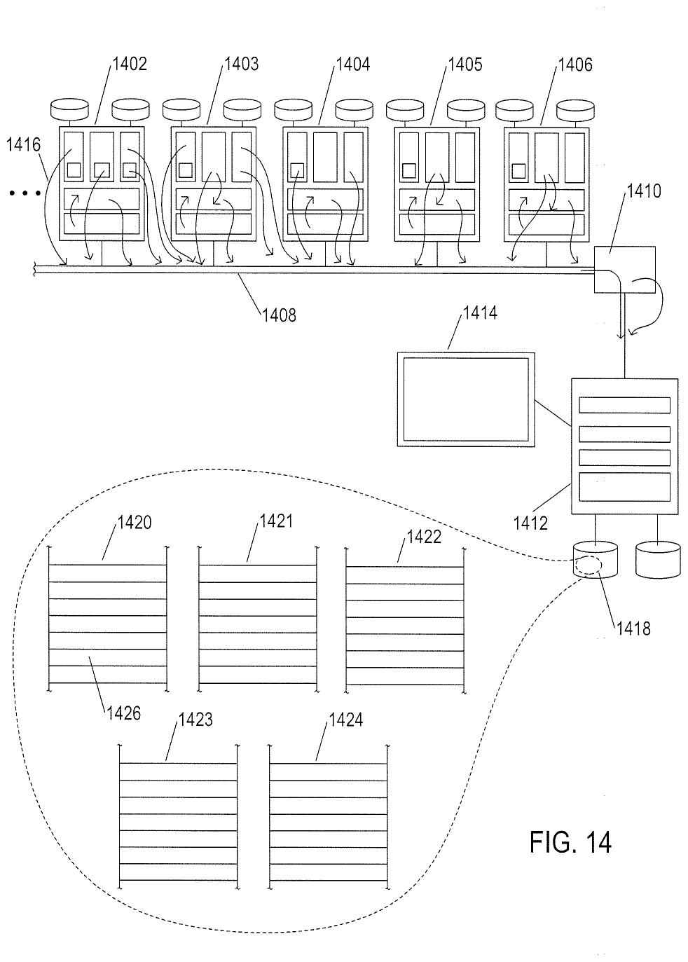

FIG. 15 shows an example source code 1502 of an event source, such as an application, an operating system, a VM, a guest operating system, or any other computer program or machine code that generates log messages. The source code 1502 is just one example of an event source that generates log messages. Rectangles, such as rectangle 1504, represent a definition, a comment, a statement, or a computer instruction that expresses some action to be executed by a computer. The source code 1502 includes log write instructions that generate log messages when certain events predetermined by a developer occur during execution of the source code 1502. For example, source code 1502 includes an example log write instruction 1506 that when executed generates a “log message 1” represented by rectangle 1508, and a second example log write instruction 1510 that when executed generates “log message 2” represented by rectangle 1512. In the example of FIG. 15, the log write instruction 1508 is embedded within a set of computer instructions that are repeatedly executed in a loop 1514. As shown in FIG. 15, the same log message 1 is repeatedly generated 1516. The same type of log write instructions may also be in different places throughout the source code, which in turns creates repeats of essentially the same type of log message in the log file.

In FIG. 15, the notation “log.write( )” is a general representation of a log write instruction. In practice, the form of the log write instruction varies for different programming languages. In general, log messages are relatively cryptic, including generally only one or two natural-language words and/or phrases as well as various types of text strings that represent file names, path names, and, perhaps various alphanumeric parameters that may identify objects, such as VMs, containers, or virtual network interfaces. In practice, a log write instruction may also include the name of the source of the log message (e.g., name of the application program, operating system and version, server computer, and network device) and the name of the log file to which the log message is recorded. Log write instructions may be written in a source code by the developer of an application program or operating system in order to record events that occur while an operating system or application program is executing. For example, a developer may include log write instructions that record events including, but are not limited to, information identifying startups, shutdowns, I/O operations of applications or devices; errors identifying runtime deviations from normal behavior or unexpected conditions of applications or non-responsive devices; fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

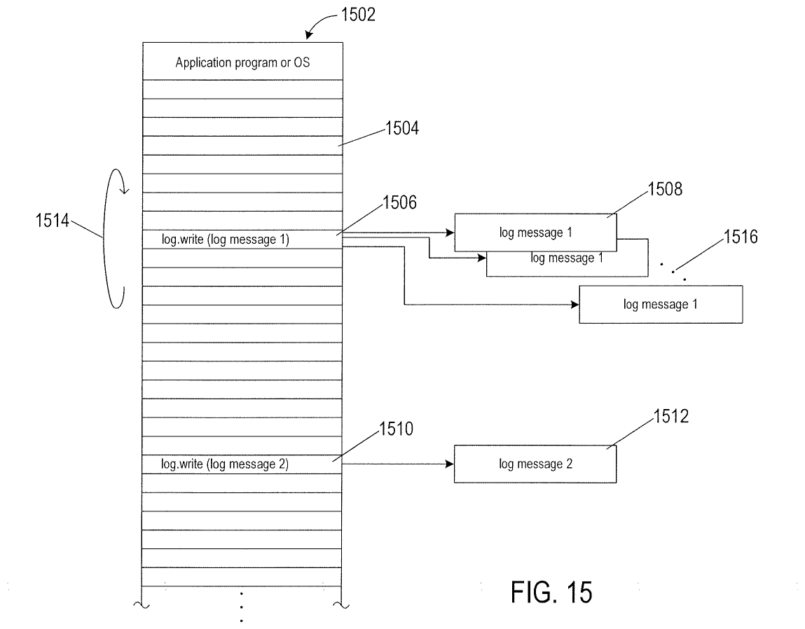

FIG. 16 shows an example of a log write instruction 1602. In the example of FIG. 16, the log write instruction 1602 includes arguments identified with “$.” For example, the log write instruction 1602 includes a time-stamp argument 1604, a thread number argument 1605, and an internet protocol (“IP”) address argument 1606. The example log write instruction 1602 also includes text strings and natural-language words and phrases that identify the type of event that triggered the log write instruction, such as “Repair session” 1608. The text strings between brackets “[]” represent file-system paths, such as path 1610. When the log write instruction 1602 is executed by a log management agent, parameters are assigned to the arguments and the text strings and natural-language words and phrases are stored as a log message of a log file.

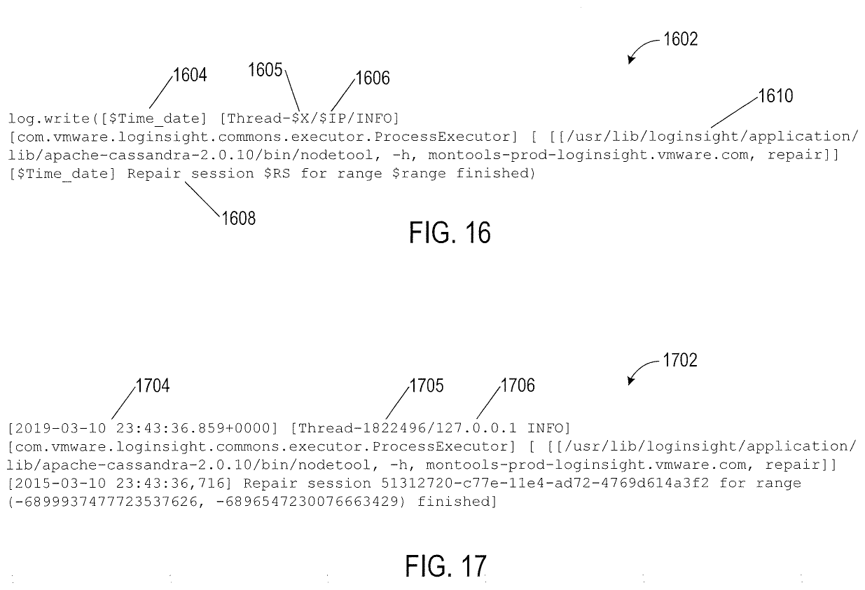

FIG. 17 shows an example of a log message 1702 generated by the log write instruction 1602. The arguments of the log write instruction 1602 may be assigned numerical parameters that are recorded in the log message 1702 at the time the log message is written to the log file. For example, the time stamp 1604, thread 1605, and IP address 1606 arguments of the log write instruction 1602 are assigned corresponding numerical parameters 1704-1706 in the log message 1702. The time stamp 1704 represents the date and time the log message is generated. The text strings and natural-language words and phrases of the log write instruction 1602 also appear unchanged in the log message 1702 and may be used to identify the type of event (e.g., informative, warning, error, or fatal) that occurred during execution of the event source.

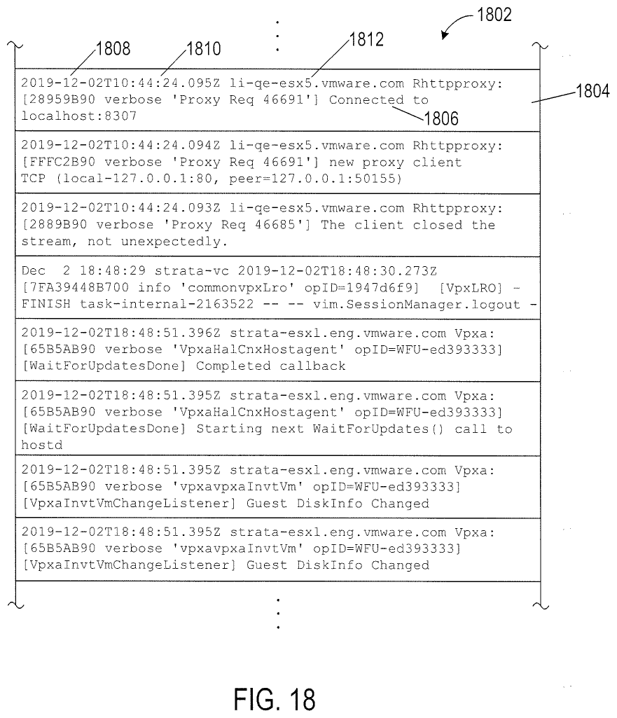

As log messages are received from various event sources, the log messages are stored in corresponding log files in the order in which the log messages are received. FIG. 18 shows a small, eight-entry portion of a log file 1802. In FIG. 18, each rectangular cell, such as rectangular cell 1804, of the portion of the log file 1802 represents a single stored log message. For example, log message 1802 includes a short natural-language phrase 1806, date 1808 and time 1810 numerical parameters, as well as, an alphanumeric parameter 1812 that appears to identify a particular host computer.

### Log Management Server

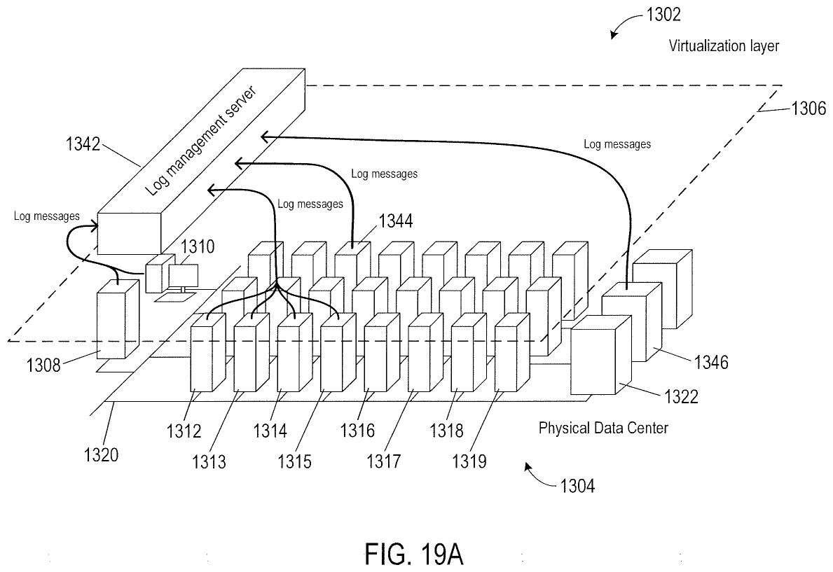

FIGS. 19A-19B show the example log management server 1342 receiving log messages from event sources. Directional arrows represent log messages sent to the log management server 1342. In FIG. 19A, operating systems and applications running on PC 1310, server computers 1308 and 1344, network devices, and mass-storage array 1346 send log messages to the log management server 1342. Operating systems and applications running on clusters of server computers may also send log messages to the log management server 1308. For example, a cluster of server computers 1312-1315 sends log messages to the log management server 1342. In FIG. 19B, guest operating systems, VMs, containers, applications, and virtual storage may independently send log messages to the log management server 1342.

A multi-tenant distributed computing system (“MTDCS”), such as a multi-tenant data center, is a facility where organizations rent server computers and storage to host their applications in VMs or containers, provide services to clients, and store data. The server computers, storage space, applications, services, and stored data are called a tenant's system. Typical processes for handling a problem with a tenant's system comprise layers of troubleshooting carried out by different teams of engineers, such as a field engineering team, an escalation engineering team, and a research and development engineering team. Within each layer, the search for the root cause may be gradually narrowed by filtering through different sub-teams. The troubleshooting process may take weeks, and in some cases months, which negatively affects users of the tenant's system and creates delays that negatively affect the reputation of the tenant to clients.

Methods and systems described below train a normal-state model that characterizes a normal state of a tenant's system based on normal log files generated by event sources of a tenant's system executed under normal or test conditions. For example, normal log files may be generated when the tenant's system is executed in test runs that simulate normal conditions. The normal log files may contain a high frequency of benign log messages and a low frequency of problem-related log messages. Benign log messages record general information that does not indicate a problem with the tenant's systems, such I/O events, logging in/out events, statistical information, status information, and comments. By contrast, problem-related log messages record problem events that require attention, such as warnings, errors, fatal events. A problem in a tenant's system may be recorded multiple times in a log file because the problem is initially unresolved, and therefore, may be repeatedly recorded in the log file whenever the same execution scenario is encountered. Methods and systems described below train a normal-state model that can be used to identify a root cause of a problem that occurs under real conditions. The normal-state model is trained on the assumptions that 1) log messages identifying a root cause of a problem are infrequent or non-existent in normal log files generated by event sources of the tenant's system operated under normal conditions and 2) log messages describing the root cause of a problem are frequently recorded in one or more of the log files produced under the real conditions at about the time when the problem occurred. A log file that records of a root cause of a problem in one or more problem-related log messages is called a “problem log file.”

Methods and systems evaluate two types of log files for a root cause of a problem with a tenant's system: 1) a problem log file that records a problem in problem-related log messages and 2) normal log files that record normal and benign states of the tenant's system in log messages. The problem log file may be identified by the tenant or an IP administrator in response to detecting an abnormality in the performance of the tenant's system. For example, clients of the tenant's system may have experienced run-time problems under real conditions and have notified the tenant. Alternatively, the tenant may have been alerted by problems exhibited by key performance indicators, such as irregular CPU or memory usage or longer than normal response times to client requests. Because words in log messages describe the normal and abnormal state of a tenant's system, methods and systems described herein compare the frequency of certain words recorded in problem-related log messages of the problem log file to words in log messages of the normal log files to identify problem-related log messages that describe a root cause of the problem without human intervention.

As described above, typical log messages share a standard format comprising a header followed by a message. The header may contain information about the version of the event source, timestamp, date, hostname, component and sub-component names, and a process identifier. The header may also provide information that identifies the type of log message, such as debug, informative, warning, error, or fatal. Methods and systems search log message headers of log messages in the problem log file for terms or phrases that identify the type of log message. For example, a warning log message may include the word “warning” or “warn” in the header, an error log message may include the word “error,” and a fatal log message may include the word “fatal,” “serious,” or “critical” The log messages that include the word or words that identify the type of log messages as a warning, error, or fatal log messages are called problem-related log messages. Methods and systems described herein are directed to identifying a root cause of a problem using one or more types of the problem-related log messages, such as warning log messages, error log messages, and fatal log messages. Problem-related log messages typically provide an indication of real problems encountered in a tenant's system.

Methods and systems train a normal-state model based on log messages recorded in normal log files. The normal log files and the problem log file are pre-processed to extract valuable plain text that can be helpful in determining a root cause of a problem with a tenant's system. Preprocessing performs event analysis on each log message of the normal log files and performs event analysis on each problem-related log message of the problem log file. Event analysis discards stop words, numbers, alphanumeric sequences, and other information from the log message that is not helpful to determining the benign or problem state of the tenant's system, leaving plaintext words called “relevant tokens” that may be used to determine the state of the tenant's system.

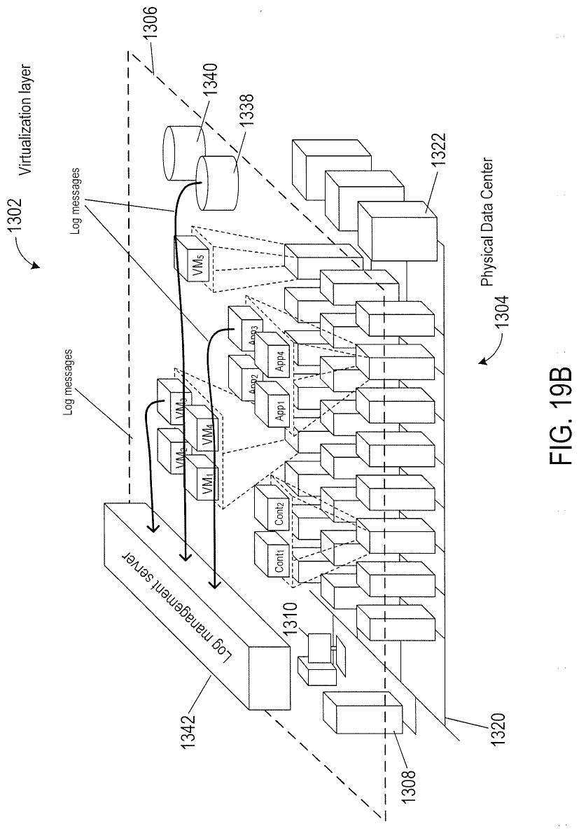

FIG. 20 shows an example of event analysis performed on an example error log message 2000. The error log message 2000 is tokenized by considering the event message as comprising tokens separated by non-printed characters, referred to as “white spaces.” Tokenization of the error log message 2000 is illustrated by underlining of the printed or visible tokens comprising characters. For example, the date 2002, time 2003, and thread 2004 of the header are underlined. Next, a token-recognition pass is made to identify stop words and parameters. Stop words are common words, such as “they,” “are,” “do,” etc. do carry any useful information. Parameters are tokens or message fields that are likely to be highly variable over a set of messages of a particular type, such as date/time stamps. Additional examples of parameters include global unique identifiers (“GUIDs”), hypertext transfer protocol status values (“HTTP statuses”), universal resource locators (“URLs”), network addresses, and other types of common information entities that identify variable aspects of an event. Stop words and parametric tokens are indicated by shading, such as shaded rectangle 2006, 2007, and 2008. Stop words and parametric tokens are discarded leaving the non-parametric text strings, natural language words and phrases, punctuation, parentheses, and brackets. Various types of symbolically encoded values, including dates, times, machine addresses, network addresses, and other such parameters can be recognized using regular expressions or programmatically. For example, there are numerous ways to represent dates. A program or a set of regular expressions can be used to recognize symbolically encoded dates in any of the common formats. It is possible that the token-recognition process may incorrectly determine that an arbitrary alphanumeric string represents some type of symbolically encoded parameter when, in fact, the alphanumeric string only coincidentally has a form that can be interpreted to be a parameter. The currently described methods and systems do not depend on absolute precision and reliability of the event-message-preparation process. Occasional misinterpretations do not result in mischaracterizing log messages. The event message 2000 is subject to textualization in which an additional token-recognition step of the non-parametric portions of the log message is performed in order to discard punctuation and separation symbols, such as parentheses and brackets, commas, and dashes that occur as separate tokens or that occur at the leading and trailing extremities of previously recognized non-parametric tokens. Uppercase letters are converted to lowercase letters. For example, letters of the word “ERROR” 2010 are converted to “error.” Alphanumeric words 2012 and 2014, such as interface names and universal unique identifiers, are discarded, leavingplaintext relevant tokens 2016.

Event analysis eliminates non-valuable elements of each log message of the normal log files, leaving relevant tokens that are used to train a normal-state model of a tenant's system. Event analysis potentially reduces the number of log messages. For example, text lines such as “channel eth0 up” of one log message and “channel eth1 up” of a second error log message are both reduced to “channel up” after event analysis. Preprocessing is applied to log messages of the normal log files and problem-related log messages of the problem log file.

Relevant tokens extracted from log messages of normal log files are used to construct an inverse document frequency (“idf”) value for each relevant token. An idf value is given by:

$$idf ( t , D ) = log \frac{N}{1 + \vert \{ d ∈ D \text{:} t ∈ d \} \vert} \qquad ( 1 )$$

where
D is the set of normal log files associated with a tenant'system executing in a distributed computing system;
d represents a normal log file in the set D;
N is the number normal log files in the set D;
t represents a relevant token; and
   |{d∈D: t∈d}| is the number of normal log files that contain the relevant token t.
   A relevant token t may appear in one or more log messages of one or more of the normal log files and not appear in other log messages of the normal log files. The set of relevant tokens associated with normal log files may be expanded to include relevant tokens often present in problem-related log messages, such as tokens that indicate warnings, errors or fatal problems often recorded in problem-related log files, and may not present in benign log messages of the normal log files. The number of normal log files that contain the relevant token t is given by

$$\vert \{ d ∈ D \text{:} t ∈ d \} \vert = {\sum }_{j = 1}^{N} {b}_{j} ( t ) \qquad ( 2 )$$

where j is a normal log file index (i.e., j=1, 2, . . . , N).
   The parameter bⱼ(t) in Equation (2) is a binary-valued token indicator that corresponds to a normal log file dⱼ, where bⱼ(t)=1 if the token t is extracted from at least one of the log messages of the normal log file dⱼ and bⱼ(t)=0 if the token t is not present in any log messages of the normal log file dⱼ.

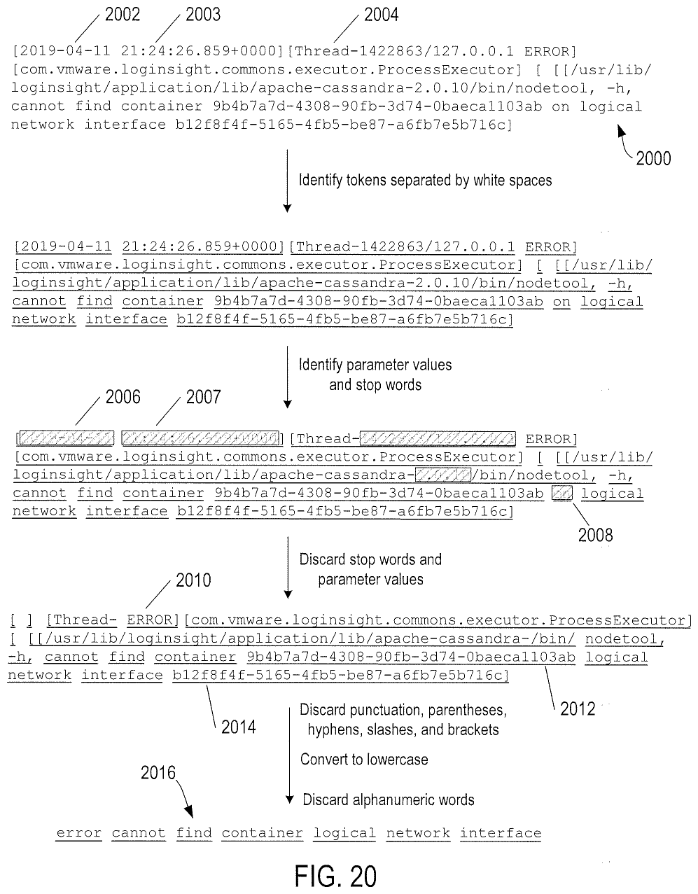

FIG. 21 shows an example of three normal log files of a set of D normal log files. The three normal log files are denoted by d₁, d₂, and d_{N}. Ellipses 2102 and 2104 represents other normal log files that are shown for convenience. Tokens are extracted from each log message of the normal log files using event analysis as described above with reference to FIG. 20. In the example of FIG. 21, t denotes a relevant token extracted from the log messages 2106-2109. Because normal log files b₁ and b_{N} have log messages with the token t, the associated binary-valued token indicators 2110 and 2112 are equal to one. Because normal log file b₂ does not have log messages with the token t, the associated binary-valued token indicator is zero 2114.

The idf values calculated for the different relevant tokens of the log messages of the set of normal log files is a normal-state model for the tenant's system. Let K be the number different relevant tokens extracted from the log messages of the set of normal log files. The normal-state model of the set of D normal log files is represented by

normal−state model={idf(tₖ, D)}ₖ₌₁^{K} (3)
where subscript “k” is a relevant token index (i.e., k=1, 2, . . . , K).

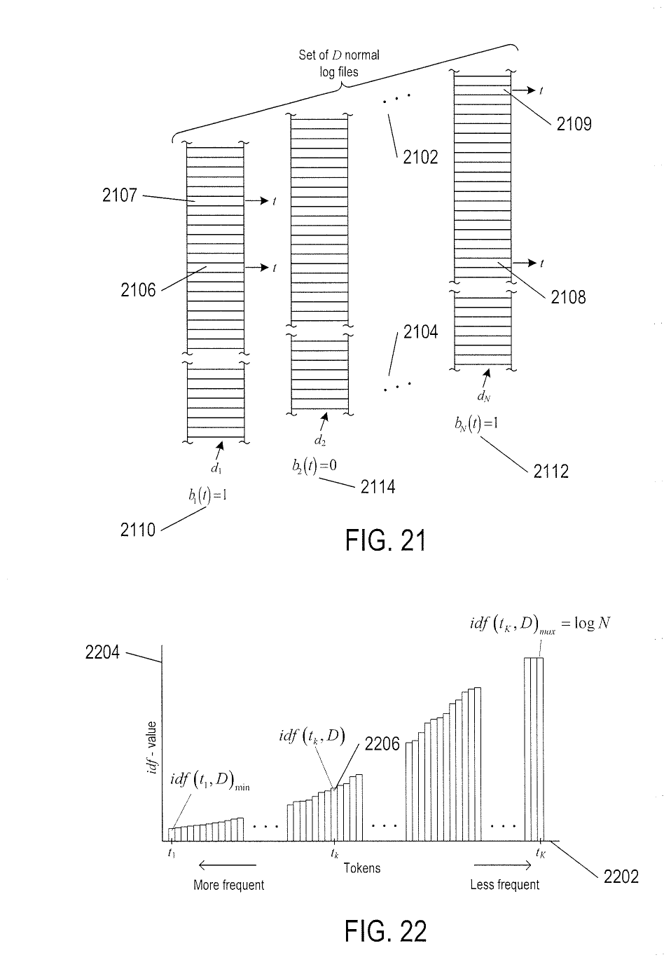

FIG. 22 shows a plot of an example normal-state model for a set of normal log files. Horizontal axis 2202 represents relevant tokens ranging from t₁ to t_{K}. Vertical axis 2204 represents a range of idf values. Bars represent the idf values calculated for each relevant token. For example, bar 2206 represents the idf value, idf (tₖ, D), of a relevant token denoted by tₖ. The relevant tokens are arranged from smallest to largest corresponding idf values with the token t₁ corresponding to the smallest idf value to the token t_{K} corresponding to the largest idf value. Larger idf values are associated with less frequent tokens (i.e., small|{d∈D: t∈d}|). By contrast, smaller idf values are associated with more frequent relevant tokens (i.e., large |{d∈D: t∈d}|). For example, relevant token t₁ is the most frequently occurring relevant token in the normal log files with a minimum idf value denoted by idf(t₁, D)ₘᵢₙ. For a relevant token that is not present in any of the log messages of the normal log files, the idf value achieves a maximum value of logN. For example, relevant token t_{K} has an idf value idf (t_{K}, D)ₘₐₓ equal to logN, indicating that the relevant token t_{K} does not occur in the log messages of the normal log files.

The idf values of the normal-state model are normalized to maximize idf value differences across the range of relevant tokens as follows:

$${idf}_{norm} ( t , D ) = \frac{idf ( t , D ) - {idf ( t , D )}_{min}}{log N - {idf ( t , D )}_{min}} \qquad ( 4 )$$

where
idfₙₒᵣₘ(t, D) is normalized idf value;
idf(t, D)ₘᵢₙ is the minimum idf value of the tokens of the set of D normal log files; and
logN is the largest idf value.
   The quantity logN is the maximum idf value corresponding to at least one relevant token that is not present in the normal log files of the set of normal log files. The normalized idf value, id fₙₒᵣₘ(t, D), is between 0 and 1, where a relevant token t with a normalized idf value equal to 0 is the most frequently represented token in the normal log files in the set D and a relevant token t with a normalized idf value equal to 1 is not present in any of the normal log files of the set D.

A problem-related log message that appears with high frequency in the problem log file is an indication that the problem-related log message may describe the root cause of the problem with the tenant's system. A relevant term frequency (“rtf”) is calculated for each relevant token in the problem-related log messages as follows:

$$rtf ( t , {d}_{p} ) = L + ( 1 - L ) \frac{{d}_{t , {d}_{p}}}{max \{ {f}_{{t}^{′} , {d}_{p}} \text{:} {t}^{′} ∈ {d}_{p} \}} \qquad ( 5 )$$

where
0<L<1 (e.g., L=0.5);
f_{t,d}_{ₚ} is the frequency of the relevant token tin the problem log file; and
dₚ represents the problem log file.

The frequency of the relevant token t is calculated by f_{t,d}_{ₚ}=n(t)/B, where n(t) is a count of the number of problem-related log messages in the problem log file that contain the relevant token t, and B is a count of the total number of problem-related log messages of the problem log file. A frequency is calculated for each relevant token in the problem-related log messages of the problem log file. Rtf values are normalized between 0 and 1 (i.e., 0<rtf (t, d_{p)<}1), avoiding a bias toward longer log files.

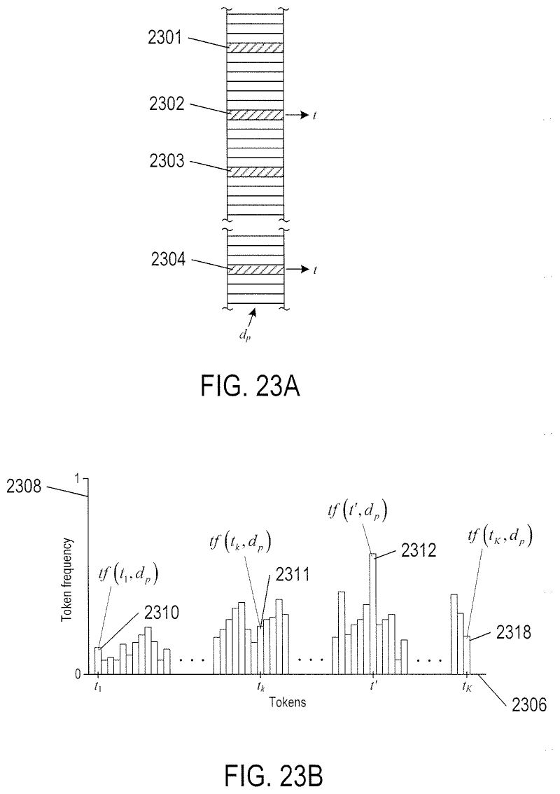

FIG. 23A shows an example of a problem log file dₚ with problem-related log messages. The problem log file may have been identified by a tenant or an IP administrator of a distributed computing system in response to detecting an abnormality in the performance of the tenant's system. Rectangles represent log messages. Shaded rectangles 2301-2304 represent problem-related log messages. Event analysis described above with reference to FIG. 20 is applied to each problem-related log message of the problem log file to determine relevant tokens. Problem-related log messages 2302 and 2304 contain a relevant token t. Problem-related log messages 2301 and 2303 do not contain the relevant token t.

FIG. 23B shows an example frequency spectrum of relevant tokens in the example problem log file dₚ. Horizontal axis 2306 represents the range of relevant tokens from t₁ to t_{K}. Vertical axis 2308 represents a relevant term frequency range of values. The range of relevant tokes corresponds to the range of relevant tokens used to construct the idf values for the set of normal log files in FIG. 22. Bars represent relevant term frequencies of the relevant tokens. For example, bars 2310-2313 represent the relevant term frequencies rtf(t₁, dₚ), rtf(tₖ, dₚ), rtf(t′, dₚ), and rtf(t_{K}, dₚ), respectively, with the largest bar 2312 corresponding to the relevant term frequency, rtf(t′, dₚ), representing the most frequent relevant token, t′, in the problem log file dₚ.

After rtfs are calculated for the relevant tokens of the problem log file, a relevant term frequency-inverse document frequency (“rtf-idf”) value is calculated for each relevant token as follows:

rtf−idf(t, dₚ, D)=rtf(t, dₚ)×idfₙₒᵣₘ(t, D) (6)

A large rtf-idf value indicates the corresponding relevant token appears infrequently in the normal log files and frequently in the problem log file, which may correspond to a problem-related log message that describes the root cause of the problem.

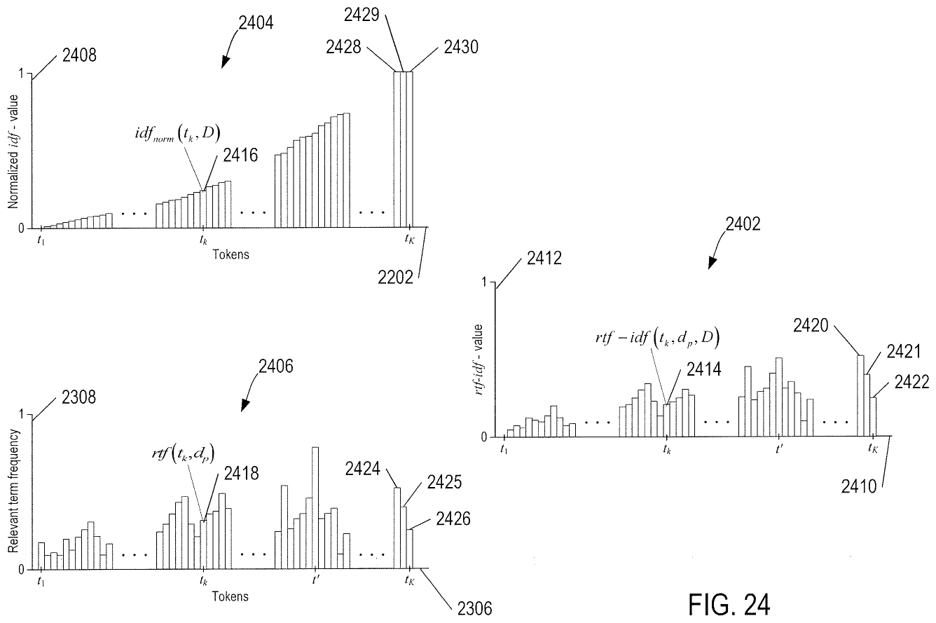

FIG. 24 shows a plot 2402 of example rtf-idf values calculated from normalized idf values and rft values. Plot 2404 shows normalized idf values of the idf values shown in FIG. 22 calculated according to Equation (4). Vertical axis 2408 represents a range of normalized idf values between 0 and 1. Plot 2406 shows the rtf values shown in FIG. 23B. Horizontal axis 2410 represents the range of relevant tokens from t₁ to t_{K} that correspond to the arrangement of relevant tokens along the axis 2202 of plots 2404 and 2406. Vertical axis 2412 represents a term frequency range of values between 0 and 1. Bars in the plot 2402 represent rtf-idf values calculated according to Equation (6) from corresponding idf and rtf values in plots 2404 and 2406, respectively. For example, rtf-idf value 2414 is the product of idf value 2416 and rtf value 2418. Note that rtf-idf values 2420-2422 in plot 2402 are equal to the rtf values 2424-2426 in plot 2406 because the corresponding relevant tokens are not present in the normal log files as indicated by corresponding idf values 2428-2430 that are equal to 1.

The rtf-idf values are aggregated for each problem-related log message of the problem log file to compute a corresponding message score. Log messages of the problem log file may be line numbered consecutively beginning with the log message with the oldest time stamp numbered 1 and ending with the most recent log message added to the problem log file dₚ. A message score for a problem-related log message is given by:

$$S ( C ) = {\sum }_{k} rtf - idf ( {t}_{k} , {d}_{p} , D ) \qquad ( 7 )$$

where
C is the line number of the problem-related log message under evaluation; and
tₖ is a relevant token of the problem-related log message.

The summation in Equation (7) is computed for aggregated, or collected, rtf-idf values associated with the problem-related log message. In one implementation, the message score of a problem-related log message is computed by aggregating all rtf-idf values associated with the problem-related log message and summing the rtf-idf values. In another implementation, the message score of a problem-related log message is computed by aggregating the largest rtf-idf values and summing the largest rtf-idf values. For example, the message score of a problem-related log message may be calculated by summing the two largest rtf-idf values. Alternatively, the message score of a problem-related log message may be calculated by summing the three largest rtf-idf values. In still another implementation, the message score of a problem-related log message may be calculated by aggregating rtf-idf values of one or more relevant tokens adject to a relevant token with the largest rtf-idf value and summing the largest rtf-idf value and the rtf-idf values of the one or more relevant tokens, provided the difference between the rtf-idf values of the adjacent relevant tokens is within a given percentage of the largest rtf-idf value, such as within 40%, 50%, 60%, or up to 80%.

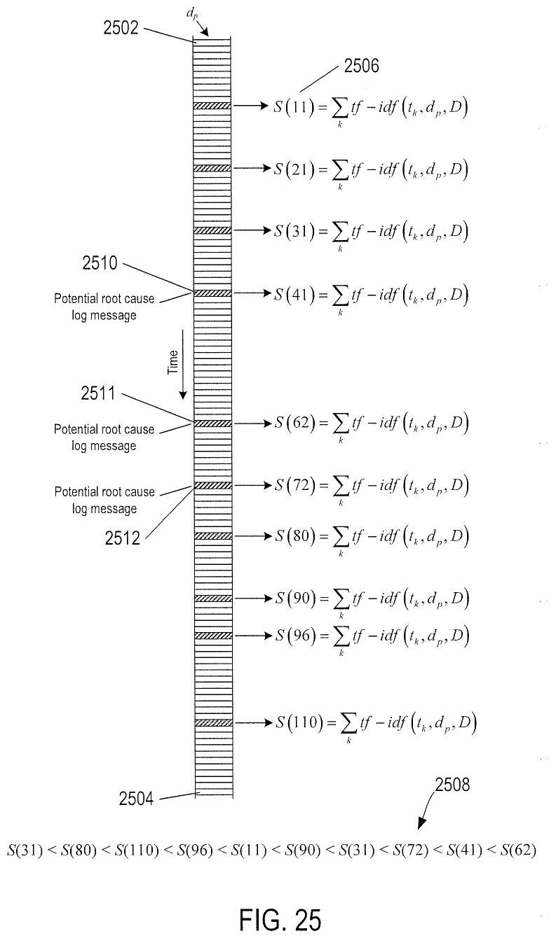

FIG. 25 shows an example of determining potential root cause problem-related log messages of a problem log file dₚ. Shaded rectangles represent problem-related log messages. The log messages are line numbered consecutively beginning with the log message with the oldest time stamp 2502 numbered 1 and ending with the most recent log message 2504 added to the problem log file dₚ. FIG. 25 shows hypothetical message scores calculated for each of the problem-related log messages. For example, S(11) 2506 is the message score of the problem-related log message at line number 11 of the problem log file. The messages scores are rank ordered from smallest to largest. FIG. 25 includes an example rank ordering 2508 of the hypothetical message scores. In this example, the log messages 2510-2512 associated with the three largest messages scores S(62). S(41), and S(72) are identified as potential root cause log messages.

In another implementation, positional information of different problem-related log messages in a problem log file with respect to a time when a problem in a tenant's system is identified may be used to aid in determining problem-related log messages that identify a root cause of a problem. For example, in the case of a system failure, or another execution problem with a tenant's system, the problem-related log messages used to identify a root cause of the problem are most likely located near the end of the problem log file because logging of log messages in the problem log file often stops shortly after the failure has occurred. In generally, a problem-related log message identifying a root cause typically has a time stamp close in time to when an execution problem is suspected of happening. Log messages of a problem log file are line numbered consecutively beginning with a log message with the oldest time stamp numbered 1 and ending with the most recent log message added to the problem log file dₚ. A position-based message score is calculated for each problem-related log message as follows:

$${S}_{pb} ( C ) = S ( C ) \times M ( C ) \\ where \\ M ( C ) = \{ \begin{matrix}( \frac{C}{T} ) log ( T ) & C \leq T \\ ( \frac{E - C}{E - T} ) log ( T ) & C > T\end{matrix} \qquad ( 8 )$$

T is the line number of the problem-related log messages closest to the suspected time of a system failure; and
E is the last line number of the problem log file.

The message weight, M(C), gives more weight to problem-related log messages with time stamps closest to the suspected time of the system failure. The message weight is largest at line number T and decays to zero at the beginning and the end of the problem log file.

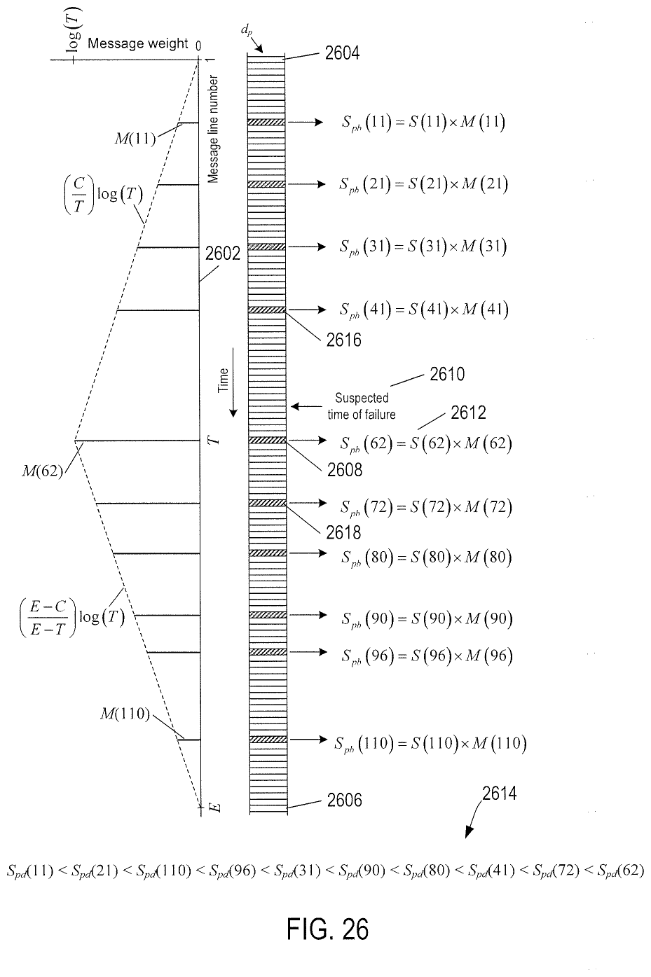

FIG. 26 shows an example of determining potential root cause problem-related log messages of the problem log file dₚ, shown in FIG. 26, using information regarding a suspected time when the tenant's system failure occurred. FIG. 26 includes a plot of the message weight M(C) over the time period of the problem log file dₚ calculated according to Equation (8). Vertical axis 2602 represents a line number axis that corresponds to line numbers assigned consecutively to log messages of the problem log file dₚ beginning with the log message with the oldest time stamp 2604 numbered 1 and ending with the number E, which is the most recent log message 2606 added to the problem log file dₚ. Time T along the line number axis 2602 is the line number of the problem-related log message 2608 with a time stamp closest to the suspected time of the failure 2610. Line segments, such as line segments labeled M(11), M(62), and M(110), are hypothetical message weights calculated according to Equation (8). FIG. 26 shows hypothetical position-based message scores calculated for each of the problem-related log messages. For example, S_{pb}(62) 2612 is the position-based message score of the problem-related log message 2608 at line number T=62 of the problem log file calculated as a product of the message score S(62) of Equation (7) and the message weight M(62) of Equation (8). The position-based message scores are rank ordered from smallest to largest. FIG. 26 includes an example rank ordering 2614 of the hypothetical position-based message scores. The position-based log messages 2608, 2616, and 2618 associated with the three highest ranked position-based messages scores S_{pb}(62), S_{pb}(41), and S_{pb}(72) are identified as potential root cause log messages. Note that in this example the position-based message scores do not have the same rank order as the corresponding position-less messages in FIG. 25.

After message scores (i.e., non-position-based messages scores of Equation (7) or position-based message scores of Equation (8)) are calculated for the problem-related log messages of the problem log file, the message scores are used to rank order the log messages. When no timing information regarding a system failure or errors is available, methods and systems may default to rank ordering of the problem-related messages scores calculated using Equation (7) to identify potential root cause log messages. The log messages with the largest associated message scores are identified as most likely describing the root cause log messages and may be used to determine the root cause of a problem with a tenant's system. For example, log messages with the largest two, three or four associated message scores may be examined to identify the root cause of a problem. The rank-ordered problem-related log messages of the problem log file may be displayed in a graphical-user interface with the highest ranked problem-related log messages identified as most likely describing a potential root cause of the problem. Alerts may be generated on a tenant's, or IP administrator's, console indicating problem-related log messages that most likely describe the root cause of a problem have been identified. Alert icons may be added to the highest rank-ordered problem-related log messages in the graphical user interface. For example, the graphical-user interface enables a user to scroll up and down a list of problem-related log messages with the highest ranked problem-related log messages located at the top of the list and identified by alert icons.

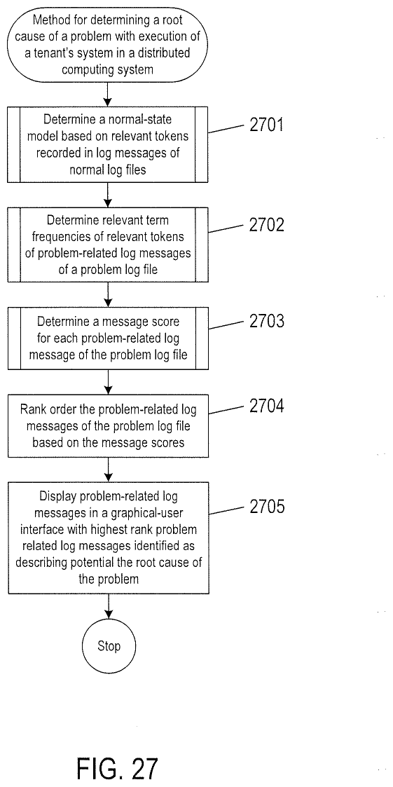

The methods described below with reference to FIGS. 27-31 are stored in one or more data-storage devices as machine-readable instructions that when executed by one or more processors of the computer system, such as the computer system shown in FIG. 1, identify problem-related log messages that describe the root cause of a problem with a tenant's system executing in a distributed computing system.

FIG. 27 is a flow diagram illustrating an example implementation of a “method for determining a root cause of a problem with execution of a tenant's system in a distributed computing system.” In block 2701, a “determine a normal-state model based on relevant tokens recorded in log messages of normal log files” procedure is performed. In block 2702, a “determine relevant term frequencies of relevant tokens of problem-related log messages of a problem log file” procedure is performed. In block 2703, a “determine a message score for each problem-related log message of the problem log file” procedure is performed. In block 2704, the problem-related log messages are rank ordered based on the associated message scores. In block 2705, rank ordered problem-related log messages are displayed in a graphical-user interface with highest rank problem-related log messages identified as describing potential root cause of the problem.

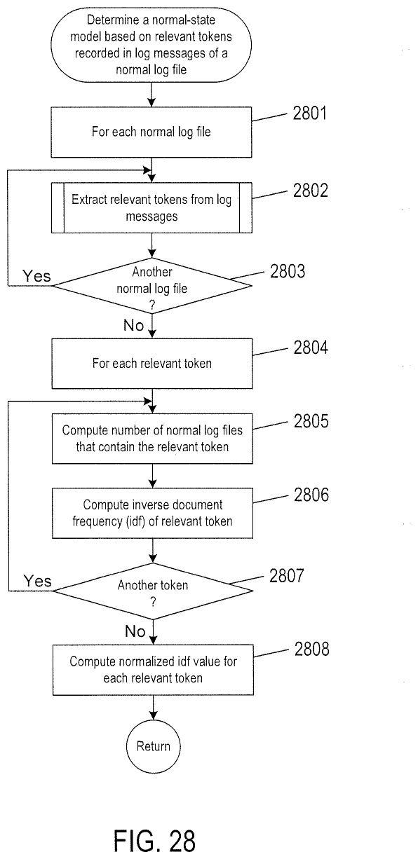

FIG. 28 is a flow diagram illustrating an example implementation of the “determine a normal-state model based on relevant tokens recorded in log messages of normal log files” step 2701 of FIG. 27. A loop beginning with block 2801 repeats the computational operations represented by blocks 2802-2807 for each normal log file. In block 2802, an “extract relevant tokens from log messages” procedure is performed on the normal log file. In decision block 2803, when relevant tokes have been extracted from the normal log files, control flows to block 2804. A loop beginning with block 2804 repeats the computational operations represented by blocks 2805-2806 for each different relevant token. In block 2804, the number of normal log files that contain the relevant token is computed according to Equation (2). In block 2805, an idf value of the relevant token is computed as described above with reference to Equation (1). In decision block 2807, control flows to block 2808 when an idf value has been computed for each of the different relevant tokens. In block 2808, normalized idf values are computed for each relevant token based on the idf values.

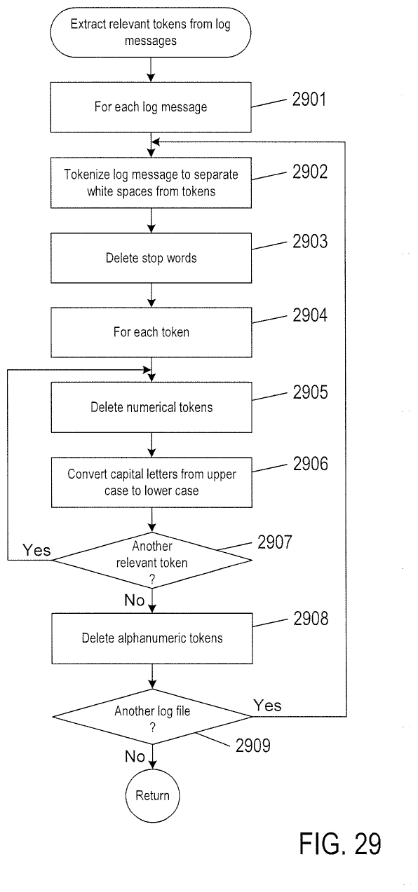

FIG. 29 is a flow diagram illustrating “extract relevant tokens from log messages” step 2802 of FIG. 28. A loop beginning with block 2901 repeats the computational operations represented by blocks 2901-2908 for each log message. In block 2902, a log message is tokenized as described above with reference to FIG. 20. In block 2903, stop words are identified and deleted from the log message. A loop beginning with block 2904 repeats the computational operations represented by blocks 2905-2906 for each token of the log message. In block 2905, numerical tokens are deleted from the log message. In block 2906, capital letters are converted from upper case to lower case. In decision block 2907, when the tokens of the log message have been considered, control flows to block 2908. In block 2908, alphanumeric tokens are deleted as described above with reference to FIG. 20. In decision block 2909, control returns when relevant tokens have been extracted from log messages.

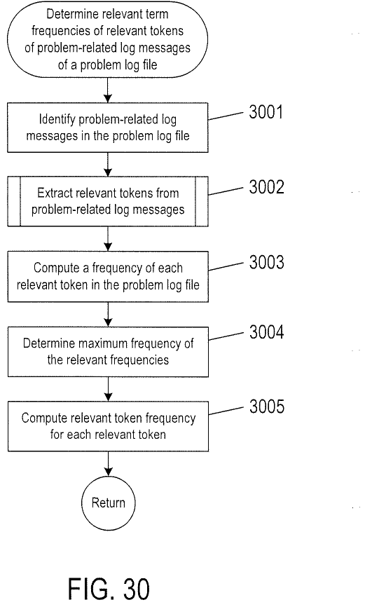

FIG. 30 is a flow diagram illustrating an example implementation of the “determine relevant term frequencies of relevant tokens of problem-related log messages of a problem log file” step 2702 of FIG. 27. In block 3001, headers of the log messages are searched to identify terms that reveal problem-related log messages of the problem log file. For example, error log messages may have been selected for event analysis. Methods and system search the headers of the log messages for a term, such as “error,” that identifies the error log messages.In block 3002, the “extract relevant tokens from log messages” is performed to extract relevant tokens from the problem-related log messages of the problem log file using the same process described above with reference to FIG. 29. In block 3003, a frequency of each relevant token is computed as described above with reference to Equation (5). In block 3004, a maximum frequency is determined from the frequencies each relevant token. In block 3005, an rtf value is computed for each relevant token as described above with reference to Equation (5).

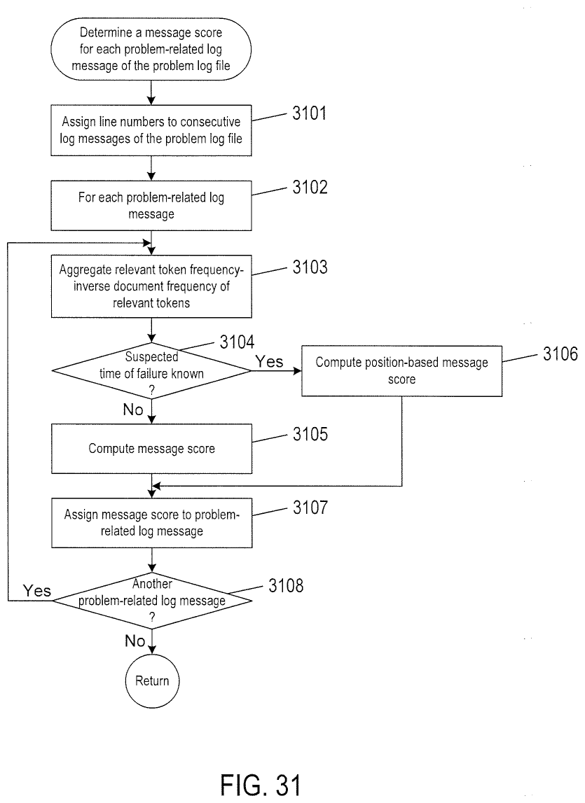

FIG. 31 shows a flow diagram illustrating an example implementation of the “determine a message score for each problem-related log message of the problem log file” step 2703 of FIG. 27. In block 3101, log messages of the problem log file are consecutively assigned a line number beginning with the log message with the oldest time stamp numbered 1 and ending with the most recent log message added to the problem log file. A loop beginning with block 3102 repeats the computational operations represented by blocks 3103-3105. In block 3103, rtf-idf values are aggregated for the relevant token as described above with reference to Equation (7). In decision block 3104, if the suspected time of a system failure, or fatal error, is known, control flows to block 3106. Otherwise, control flows to block 3105. In block 3105, a message score is computed as described above with reference to Equation (7). In block 3106, a position-based message score is computed as describe above with reference to Equation (8). In block 3107, the message score determined in block 3105 or in block 3106 is assigned the problem-related log message. In decision block 3108, control returns to FIG. 27 when messages scores have been computed for the problem-related log messages of the problem log file.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method stored in one or more data-storage devices and executed using one or more processors of a computer system for determining a root cause of a problem with execution of a tenant's system in a distributed computing system, the method comprising:
determining a normal-state model based on relevant tokens recorded in log messages of normal log files associated with the tenant's system;
determining relevant term frequencies of relevant tokens of problem-related log messages of a problem log file associated with the tenant's system;
determining a message score for each problem-related log message of the problem log file based on the normal-state model and the relevant term frequencies; and
rank ordering the problem-related log messages based on the message scores, wherein highest ranked problem-related log messages potentially describe the root cause of the problem with execution of the tenant's system.

2. The method of claim 1 wherein determining the normal-state model based on the relevant tokens recorded in the log messages of the normal log files comprises:
extracting relevant tokens from log messages of each normal log file;
for each relevant token
computing a number of normal log files that contain the relevant token, and
computing an inverse document frequency value of the relevant token based on the number of normal log files that contain the relevant token; and
computing a normalized inverse document frequency value for each relevant token based on the inverse document frequency values.

3. The method of claim 1 wherein determining the relevant term frequencies of the relevant tokens of the problem-related log messages of the problem log file comprises:
identifying problem-related log messages of the problem log file;
extracting relevant tokens from the problem-related log messages of the problem log file.
computing a frequency for each relevant token;
determining a maximum frequency of the frequencies; and
computing a relevant term frequency value for each relevant token.

4. The method of claim 1 wherein determining the message score for each problem-related log message of the problem log file comprises:
assigning consecutive line numbers to each log message of the problem log file beginning with the log message having an oldest time stamp and ending with a most recent log message recorded in the problem log file; and
for each problem-related log message of the problem log file
aggregating relevant term frequency-inverse domain frequency values of relevant tokens, and
computing a message score based on the aggregated relevant term frequency-inverse domain frequency values.

5. The method of claim 1 wherein determining the message score for each problem-related log message of the problem log file comprises:
assigning consecutive line numbers to each log message of the problem log file beginning with the log message having an oldest time stamp and ending with a most recent log message recorded in the problem log file;
determining a time stamp of a problem-related log message of the problem log file located closest to a suspected time when the problem occured; and
for each problem-related log message of the problem log file
aggregating relevant term frequency-inverse domain frequency values of relevant tokens,
computing a message weight based the line number of the problem-related log message and the time stamp, and
computing a message score based on the aggregated relevant term frequency-inverse domain frequency value.

6. The method of claim 1 further comprising displaying the problem-related log messages of the problem log file in a graphical-user interface with highest ranked problem-related log messages identified as describing a potential root cause of the problem.

7. A computer system determining a root cause of a problem with execution of a tenant's system in a distributed computing system, the system comprising:
one or more processors;
one or more data-storage devices; and
machine-readable instructions stored in the one or more data-storage devices that when executed using the one or more processors controls the system to perform the operations comprising:
determining a normal-state model based on relevant tokens recorded in log messages of normal log files associated with the tenant's system;
determining relevant term frequencies of relevant tokens of problem-related log messages of a problem log file associated with the tenant's system;
determining a message score for each problem-related log message of the problem log file based on the normal-state model and the relevant term frequencies; and
rank ordering the problem-related log messages based on the message scores, wherein highest ranked problem-related log messages potentially describe the root cause of the problem with execution of the tenant's system.

8. The computer system of claim 7 wherein determining the normal-state model based on the relevant tokens recorded in the log messages of the normal log files comprises:
extracting relevant tokens from log messages of each normal log file;
for each relevant token
computing a number of normal log files that contain the relevant token, and
computing an inverse document frequency value of the relevant token based on the number of normal log files that contain the relevant token; and
computing normalized inverse document frequency values for each relevant token based on the inverse document frequency values.

9. The computer system of claim 7 wherein determining the relevant term frequencies of the relevant tokens of the problem-related log messages of the problem log file comprises:
identifying problem-related log messages of the problem log file;
extracting relevant tokens from the problem-related log messages of the problem log file.
computing a frequency for each relevant token;
determining a maximum frequency of the frequencies; and
computing a relevant term frequency value for each relevant token.

10. The computer system of claim 7 wherein determining the message score for each problem-related log message of the problem log file comprises:
assigning consecutive line numbers to each log message of the problem log file beginning with the log message having an oldest time stamp and ending with a most recent log message recorded in the problem log file; and
for each problem-related log message of the problem log file
aggregating relevant term frequency-inverse domain frequency values of relevant tokens, and
computing a message score based on the aggregated relevant term frequency-inverse domain frequency values.

11. The computer system of claim 7 wherein determining the message score for each problem-related log message of the problem log file comprises:
assigning consecutive line numbers to each log message of the problem log file beginning with the log message have an oldest time stamp and ending with a most recent log message recorded in the problem log file;
determining a time stamp of a problem-related log message of the problem log file located closest to a suspected time when the problem occurred; and
for each problem-related log message of the problem log file
aggregating relevant term frequency-inverse domain frequency values of relevant tokens,
computing a message weight based the line number of the problem-related log message and the time stamp, and
computing a message score based on the aggregated relevant term frequency-inverse domain frequency value.

12. The computer system of claim 7 further comprising displaying the problem-related log messages of the problem log file in a graphical-user interface with highest ranked problem related log messages identified as describing a potential root cause of the problem.

13. A non-transitory computer-readable medium encoded with machine-readable instructions that implement a method carried out by one or more processors of a computer system to perform the operations comprising:
determining a normal-state model based on relevant tokens recorded in log messages of normal log files associated with a tenant's system executing in a distributed computing system;
determining relevant term frequencies of relevant tokens of problem-related log messages of a problem log file associated with the tenant's system;
determining a message score for each problem-related log message of the problem log file based on the normal-state model and the relevant term frequencies; and
rank ordering the problem-related log messages based on the message scores, wherein highest ranked problem-related log messages potentially describe the root cause of the problem with execution of the tenant's system.

14. The medium of claim 13 wherein determining the normal-state model based on the relevant tokens recorded in the log messages of the normal log files comprises:
extracting relevant tokens from log messages of each normal log file;
for each relevant token
computing a number of normal log files that contain the relevant token, and
computing an inverse document frequency value of the relevant token based on the number of normal log files that contain the relevant token; and
computing normalized inverse document frequency values for each relevant token based on the inverse document frequency values.

15. The medium of claim 13 wherein determining the relevant term frequencies of the relevant tokens of the problem-related log messages of the problem log file comprises:
identifying problem-related log messages of the problem log file;
extracting relevant tokens from the problem-related log messages of the problem log file.
computing a frequency for each relevant token;
determining a maximum frequency of the frequencies; and
computing a relevant term frequency value for each relevant token.

16. The medium of claim 13 wherein determining the message score for each problem-related log message of the problem log file comprises:
assigning consecutive line numbers to each log message of the problem log file beginning with the log message having an oldest time stamp and ending with a most recent log message recorded in the problem log file; and
for each problem-related log message of the problem log file
aggregating relevant term frequency-inverse domain frequency values of relevant tokens, and
computing a message score based on the aggregated relevant term frequency-inverse domain frequency values.

17. The medium of claim 13 wherein determining the message score for each problem-related log message of the problem log file comprises:
assigning consecutive line numbers to each log message of the problem log file beginning with the log message having an oldest time stamp and ending with a most recent log message recorded in the problem log file;
determining a time stamp of a problem-related log message of the problem log file located closest to a suspected time when the problem occurred; and
for each problem-related log message of the problem log file
aggregating relevant term frequency-inverse domain frequency values of relevant tokens,
computing a message weight based the line number of the problem-related log message and the time stamp, and
computing a message score based on the aggregated relevant term frequency-inverse domain frequency value.

18. The medium of claim 13 further comprising displaying the problem-related log messages of the problem log file in a graphical-user interface with highest ranked problem related log messages identified as describing a potential root cause of the problem.
